(19) United States
(12) Patent Application Publication
(10) Pub. No.: US 2025/0021354 A1
(43) Pub. Date: Jan. 16, 2025

(54) METHOD FOR INFORMATION INTERACTION, DEVICE, AND STORAGE MEDIUM

(71) Applicant: Beijing Zitiao Network Technology Co., Ltd., Beijing (CN)

(72) Inventors: Chen ZHAO, Beijing (CN); Yanting HUA, Beijing (CN); Zhengdong ZHAO, Beijing (CN); Tong WEI, Beijing (CN)

(21) Appl. No.: 18/713,106

(22) PCT Filed: Dec. 22, 2022
(86) PCT No.: PCT/CN2022/140869

§ 371 Date: May 23, 2024

(30) Foreign Application Priority Data
Jan. 12, 2022 (CN) 202210032032.4

(51) Int. Cl. G06F 9/451

(52) U.S. Cl. CPC G06F 9/451

(57) ABSTRACT

A method and apparatus for information interaction, a device, and a storage medium are provided. The method for information interaction includes: selecting a first target effect based on an effect selection operation input by a first user for a target object, where the target object is associated with a preset theme; playing the first target effect in response to receiving a preset playing instruction for the target object; and in response to meeting a preset condition, showing interaction task information associated with the preset theme.

### CROSS-REFERENCE TO RELATED APPLICATION

The present application claims priority of the Chinese Patent Application No. 202210032032.4, filed on Jan. 12, 2022, the entire disclosure of which is incorporated herein by reference as part of the present application.

### TECHNICAL FIELD

The present disclosure relate to the technical field of computers, and for example, to a method and apparatus for information interaction, a device, and a storage medium.

### BACKGROUND

With the rapid development of the computer technology, the functions of an application (App) become increasingly rich, bringing about lots of fun for users' daily life while providing convenience for peoples' work and life.

To enrich the functions of an App, an App program platform may provide a plurality of themes and perform information interaction with users based on a theme. However, an information interaction manner based on a theme is tedious and needs to be improved.

### SUMMARY

Embodiments of the present disclosure provides a method and apparatus for information interaction, a storage medium, and a device to optimize the solution for information interaction.

In a first aspect, the present disclosure provide a method for information interaction, and the method includes:
determining a first target effect based on an effect selection operation input by a first user for a target object, where the target object is associated with a preset theme;
playing the first target effect in response to receiving a preset playing instruction for the target object; and
in response to determining that a preset condition is met, showing interaction task information associated with the preset theme.

In a second aspect, the present disclosure provide an apparatus for information interaction, and the apparatus includes:
an effect determining module, configured to determine a first target effect based on an effect selection operation input by a first user for a target object, where the target object is associated with a preset theme;
an effect playing module, configured to play the first target effect in response to receiving a preset playing instruction for the target object; and
an information showing module, configured to show interaction task information associated with the preset theme in response to determining that a preset condition is met.

In a third aspect, the present disclosure provide an electronic device, and the electronic device includes a memory, a processor, and computer programs stored on the memory and runnable on the processor. The processor, upon executing the computer programs, implements the above method for information interaction.

In a forth aspect, the present disclosure provide a computer-readable storage medium storing computer programs. The programs, upon being executed by a processor, implement the above method for information interaction.

In a fifth aspect, the present disclosure provide a computer program product, which includes computer programs carried on a non-transitory computer-readable medium. The computer programs include program codes for executing the above method for information interaction.

### BRIEF DESCRIPTION OF DRAWINGS

FIG. 1 is a flowchart of a method for information interaction provided in an embodiment of the present disclosure;

FIG. 2 is a flowchart of another method for information interaction provided in an embodiment of the present disclosure;

FIG. 3 is a schematic diagram of page interaction provided in an embodiment of the present disclosure;

FIG. 4 is a structural block diagram of an apparatus for information interaction provided in an embodiment of the present disclosure; and

FIG. 5 is a structural block diagram of an electronic device provided in an embodiment of the present disclosure.

### DETAILED DESCRIPTION

Embodiments of the present disclosure are described in detail below with reference to the drawings. Although some embodiments of the present disclosure are shown in the drawings, the present disclosure may be achieved in a plurality of forms. These embodiments are provided to understand the present disclosure. The drawings and the embodiments of the present disclosure are only for exemplary purposes.

A plurality of steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

Concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise stated in the context, it should be understood as “one or more”.

Names of messages or information exchanged between a plurality of apparatuses in embodiments of the present disclosure are only used for the purpose of description and not meant to limit the scope of these messages or information.

Both of optional features and examples are provided in the embodiments as will be described below. A plurality of features described in the embodiments may be combined to form a plurality of optional solutions. Each numbered embodiment shall not be merely considered as a technical solution.

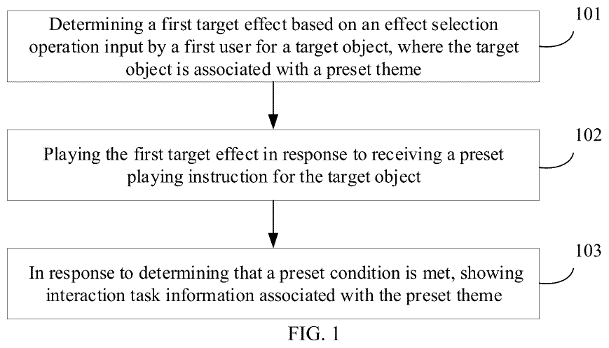

FIG. 1 is a flowchart of a method for information interaction provided in an embodiment of the present disclosure. The method may be performed by an apparatus for information interaction. The apparatus may be implemented by software and/or hardware and may be generally integrated in an electronic device. The electronic device may be a mobile device such as a mobile phone, a smart watch, a tablet computer, and a personal digital assistant, and may also be another device such as a desktop computer. As shown in FIG. 1, the method includes the following steps.

At step 101, a first target effect is determined based on an effect selection operation input by a first user for a target object, where the target object is associated with a preset theme.

In an embodiment of the present disclosure, the preset theme may be a theme set by a platform of the preset App. There is no limitation on a theme type, a theme content and the like. For example, a theme related to a festival (such as Spring Festival, Valentine's Day, or Teeth-Care Day), a theme related to an event (such as first snow, school opening, or new App function), or other themes set by the platform may be possible. For example, the theme may be an activity launched by the platform of the preset App, such as a Spring Festival activity. There is no limitation on the type of the preset App, such as a social App, a live streaming App, a video App, or an information App.

Exemplarily, for the preset theme, a relevant object capable of reflecting the characteristics of the theme may be designed. There is no limitation on the number of objects. The object in the embodiment of the present disclosure may be a virtual object (e.g., a cartoon image) and may also be an entity object (e.g., a real object or a user's photo). For example, for the Spring Festival theme, the object may include, for example, fireworks, Chinese Zodiac, spring festival scrolls, or dumplings. For the first snow theme, the object may include, for example, snow, snowman, or snowball. The target object may be an object currently selected by the first user or an object currently presented for the first user. The first user may be a current user using the electronic device. For different objects, a plurality of animation effects (hereinafter referred to as effects for short) corresponding to each object may be preset, and each effect is used as a candidate effect, thereby forming a candidate effect set.

Exemplarily, an interaction entry of the preset theme may be displayed in the preset App. After triggering the interaction entry, the first user may enter a theme page corresponding to the preset theme, and the first user may input related operations based on the theme page. For example, the candidate effect set corresponding to the target object may be shown in the theme page. There is no limitation on a showing manner. For example, a names or an identifier of the candidate effect may be shown, and a static preview image or a dynamic preview image of the candidate effect may also be shown. The first user may input the effect selection operation via the theme page, and the candidate effect indicated by the effect selection operation is determined as the first target effect currently selected by the first user. That is, the first target effect is determined from the candidate effect set in accordance with the effect selection operation input by the first user based on the candidate effect set. For example, after receiving the effect selection operation, a preview effect of the first target effect is played in the theme page.

At step 102, the first target effect is played in response to receiving a preset playing instruction for the target object.

In an embodiment of the present disclosure, the preset playing instruction may be automatically generated by a system, e.g., automatically generated after the first target effect is determined, thus achieving the effect of automatically playing the first target effect after the first user finishes selecting the first target effect. The preset playing instruction may also be generated in response to a triggering operation of the first user. For example, a preset control is displayed in the theme page, and after the first user triggers the preset control, the preset playing instruction is generated, thereby achieving the effect of determining a time when the first target effect is played according to the triggering by the user.

Exemplarily, the first target effect may be played in a page for receiving the effect selection operation, e.g., in the theme page described above, or may be played in other page, e.g., an effect playing page. After receiving the preset playing instruction for the target object, a skip may be made to the effect playing page and the first target effect is played.

At step 103, interaction task information associated with the preset theme is shown in response to determining that a preset condition is met.

In an embodiment of the present disclosure, one or more interaction tasks may be set for the preset theme. After the user performs information interaction for an interaction task, information related to the interaction task may be shown. After the user selects the target effect, the target effect is played successfully. It thus may be considered that the user performs information interaction based on the preset theme. The preset condition may be set, and it may be determined whether the interaction task information associated with the preset theme is shown by determining whether the preset condition is met. The preset may be, for example, the playing of the first target effect is completed. The interaction task and the interaction task information may be set according to the characteristics of the preset App, the characteristics of the preset theme, or actual business requirements, which will not be limited. Completing the playing of the target effect may be regarded as an interaction task.

Exemplarily, showing the interaction task information associated with the preset theme includes at least one of: showing interaction task completion information of the preset theme fed back to the first user; showing an interaction entry of a target interaction sub-task associated with the preset theme that is assigned to the first user; and showing statistical information of users who have performed information interaction based on the preset theme.

Exemplarily, after determining that the first user performs information interaction based on the preset theme, the interaction task completion information may be fed back to the first user. The interaction task completion information may be, for example, a credit, a virtual item, a permission to a preset function, or a participation qualification for a preset task provided by the preset App. A showing manner of the interaction task completion information may include displaying a message containing completion information, displaying an image or a floating window containing a completion information content, or the like.

Exemplarily, after determining that the first user performs information interaction based on the preset theme, the target interaction sub-task associated with the preset theme may be assigned to the first user, and the user may accelerate the completion progress of the interaction task associated with the preset theme by completing the target interaction sub-task. For example, the interaction entry of a target interaction sub-task may be shown, and the first user may know the details of the target interaction sub-task or input a target operation specified by the target interaction sub-task by triggering the interaction entry. There is no limitation on a type of the target interaction sub-task. For example, the target interaction sub-task may be viewing a video or inviting a friend to participate in information interaction of the preset theme. The type of the target interaction sub-task may be set according to an actual requirement.

Exemplarily, after determining that the first user has performed information interaction based on the preset theme, the statistical information of users who have performed information interaction based on the preset theme may be shown to the first user, helping the first user to know the interaction progress of the preset theme. For example, the statistical information may include a number of participating users or a number of times of participation by the participating users.

According to the method for information interaction provided in the embodiment of the present disclosure, the first target effect is determined based on the effect selection operation input by the first user for the target object, where the target object is associated with the preset theme. The first target effect is played in response to receiving the preset playing instruction for the target object. The interaction task information associated with the preset theme is shown in response to determining that the preset condition is met. By adopting the above technical solution, when performing information interaction based on the preset theme, the user may autonomously select the effect of the object associated with the preset theme and trigger showing the interaction task information associated with the preset theme by playing the effect. A novel theme-based information interaction manner is provided for the user; the interestingness of information interaction is improved; the information interaction forms are enriched; and the functions of an App are enriched.

In some embodiments, the determining the first target effect based on the effect selection operation input by the first user for the target object includes: determining a target effect type based on an effect type selection operation input by the first user for the target object; and receiving a setting operation input by the first user for the target effect type and determining the first target effect of the target object based on the setting operation. Such a setting has the following advantages: the effects may be classified in advance; a user may select a type first and then perform personalized setting on the selected type; the effect styles are enriched while the effect selection efficiency is improved; and the personalized demand of the user is met. A division way for the effects may be designed according to the characteristics of the target object. Each effect type corresponds to at least one effect.

In some embodiments, the target effect type includes a text type effect. The receiving the setting operation input by the first user for the target effect type and determining the first target effect of the target object based on the setting operation includes: showing an alternative copywriting corresponding to the target object, receiving a copywriting selection operation input by the first user for the alternative copywriting, and determining the first target effect of the target object based on a target alternative copywriting indicated by the copywriting selection operation. Such a setting has the following advantages: for the text type effect, corresponding effects are designed in advance for different alternative copywriting; and the time taken to generate the effects is reduced and the effect determination efficiency is improved, whilst the personalized demand of the user is met.

In some embodiments, the receiving the setting operation input by the first user for the target effect type and determining the first target effect of the target object based on the setting operation includes: receiving a self-defined copywriting input by the first user and determining the first target effect of the target object based on the self-defined copywriting. Such a setting has the following advantages: a higher degree of freedom of copywriting design may be provided for the user; the personalized demand of the user is met; and the interaction forms are enriched.

In some embodiments, after the playing the first target effect in response to receiving the preset playing instruction for the target object, the method further includes: displaying a preset playing control; and playing a preset atmospheric effect associated with the first target effect in the process of playing the first target effect in response to a triggering operation for the preset playing control. Such a setting has the following advantages: in the process of playing the target effect, the user is allowed to continue triggering the playing of the associated atmospheric effect; the contents to be played are enriched and the effect playing effect is improved; the user is enabled to view a more beautiful effect playing page in the process of performing information interaction based on the preset theme; the interestingness of information interaction is improved; and the information interaction forms are enriched.

Exemplarily, the preset atmospheric effect may be a background effect or a subordinate effect set for the first target effect in advance to set off the first target effect. The preset atmospheric effect may contain a content related to the first target effect, and may belong to a same type with or different types from the first target effect, without limitation. The size of the preset atmospheric effect may be smaller than that of the first target effect; or, the transparency of the preset atmospheric effect may be higher than that of the first target effect (e.g., the preset atmospheric effect is semitransparent and the first target effect is non-transparent); or, the color of the preset atmospheric effect belongs to the same color system with that of the first target effect, but has a lower color saturation than the first target effect.

In some embodiments, the playing a preset atmospheric effect associated with the first target effect includes: determining a current cumulative number of times of triggering the preset playing control, determining a target preset atmospheric effect associated with the first target effect based on the current cumulative number of times of triggering, and playing the target preset atmospheric effect. Different cumulative numbers of times of triggering may correspond to the same or different target preset atmospheric effects to be played. Such a setting has the following advantages: the user is allowed to trigger the preset playing control for a plurality of times; and with the number of times of triggering increasing, the atmospheric effect is dynamically superposed in the effect playing page by triggering each time, thereby improving the visual experience of effect playing.

In some embodiments, after the determining the first target effect based on the effect selection operation input by the first user for the target object, the method further includes: determining a second user matching the first user and determining a second target effect selected by the second user. The playing the first target effect in response to receiving the preset playing instruction for the target object includes: detecting that the first user and the second user trigger a playing operation on the target object in a same preset period of time, determining a target composite effect based on the first target effect and the second target effect, and playing the target composite effect. Such a setting has the following advantages: a plurality of users may be allowed to together participate in selection and playing of a same effect; the interaction between the users is enhanced; the interestingness of information interaction based on the preset theme is improved; and the information interaction forms are enriched.

Exemplarily, the second user may be a user different from the first user. The number of the second users is not limited. The electronic device used by the second user is different from that used by the first user. The first user may send an invitation to the second user through the preset App. The preset App may also automatically match the second user for the first user after the first user originates a user matching request. As an implementation, a composite effect may be set in advance. The composite effect is divided into a plurality of effects, and the plurality of effects are respectively distributed to the devices used by different users for selection by the users. Generally, the effects selected by different users are different. For example, the composite effect is divided into effect 1, effect 2, and effect 3. The 3 effects are respectively distributed to user a, user b, and user c. For the user a, the 3 effects may be viewed. If the user b and the user c do not select an effect at this time, the user a may select any effect therefrom. If the user b has selected the effect 1, the user a may select the effect 2 or the effect 3.

In some embodiments, the playing the first target effect in response to receiving the preset playing instruction for the target object includes: determining a target playing background associated with the first user and/or the first target effect in response to receiving the preset playing instruction for the target object, and playing the first target effect based on the target playing background. Such a setting has the following advantage: the corresponding target playing background is determined based on the first user and/or the first target effect selected by the first user, which is conducive to setting off the playing of the first target effect and improving the effect playing effect.

Exemplarily, for the first user, the corresponding target playing background may be determined based on a user attribute of the first user in the preset App. For example, the target playing background containing a target city landscape may be selected based on a target city where the first user is located. In an embodiment of the present disclosure, after an authorization for acquiring the information of a city where a user is located is obtained, the city where the user is located is determined. For example, inquiry information of whether to allow the information of the city to be acquired is displayed in the page, and after the user selects the option “allow”, the city where the user is located is determined. For the first target effect, the corresponding target playing background is determined based on an effect attribute of the first target effect. For example, based on a target tone of the first target effect and the like, the target playing background having a tone difference of greater than a preset threshold from the target tone may be determined to set off the playing of the first target effect.

In some embodiments, the determining the first target effect based on the effect selection operation input by the first user for the target object includes: determining a candidate effect set corresponding to the target object based on progress information of the first user performing an interaction task associated with the preset theme; and showing the candidate effect set and determining the first target effect in accordance with the effect selection operation input by the first user based on the candidate effect set. The progress information may include, for example, the number of times of triggering showing interaction task information as operated by the first user. Such a setting has the following advantages: an interaction frequency of the first user may be determined based on the progress information of the interaction task of the first user; more effects may be provided for a user for whom the interaction frequency is high; the interestingness of information interaction is improved; and the information interaction forms are enriched.

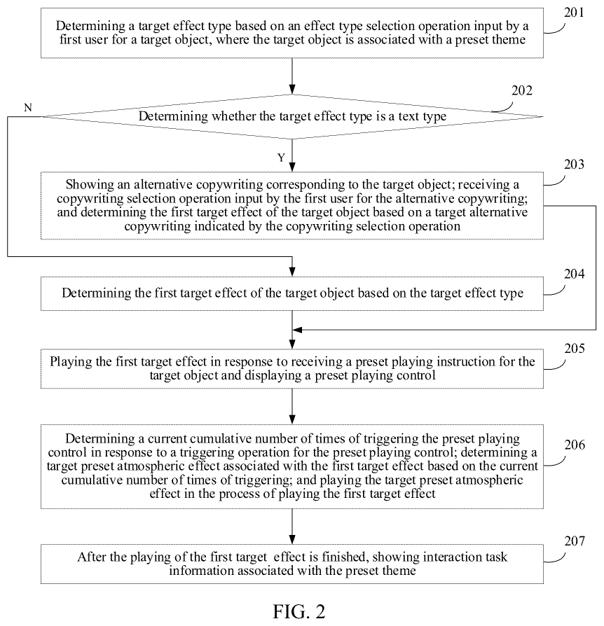

FIG. 2 is a flowchart of another method for information interaction provided in an embodiment of the present disclosure, which is illustrated on the basis of the scheme in the above embodiments. The method includes the following steps.

At step 201, a target effect type is determined based on an effect type selection operation input by a first user for a target object, where the target object is associated with a preset theme.

Exemplarily, an effect type display region may be shown in a theme page of the preset theme to show a plurality of effect types for selection by the user.

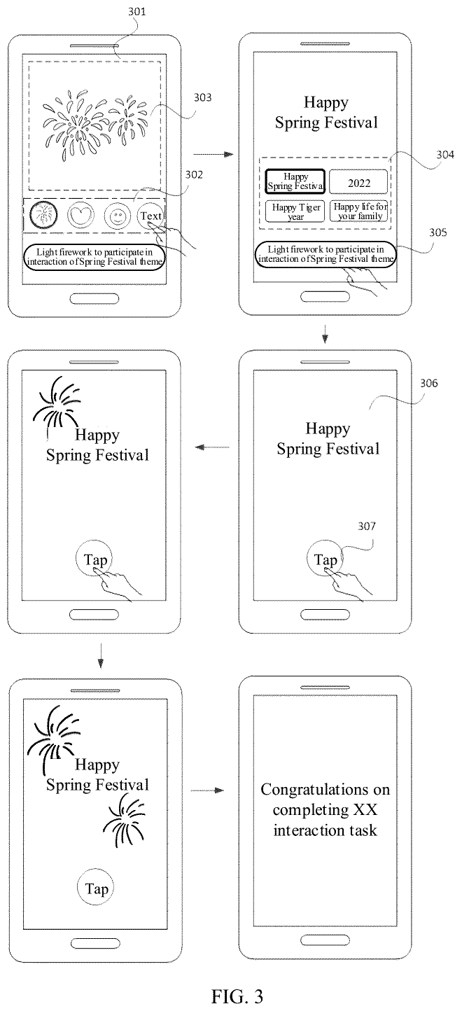

FIG. 3 is a schematic diagram of page information interaction provided in an embodiment of the present disclosure. Taking for example that the preset theme is the Spring Festival theme, the target object is virtual fireworks, and the manner of information interaction based on the Spring Festival theme is playing the firework effect. The effect type display region 302 is displayed in the theme page 301, and icons of a plurality of effect types are displayed in the effect type display region 302, assumed to include a simulated firework type, a heart-shaped firework type, a virtual image firework type, a text firework type, and the like. The user may trigger an icon by tapping and the like, thereby realizing the selection of an effect type. An icon currently in a selected state may be displayed in a different manner from icons in an unselected state. For example, the borders of the icon in the selected state are in bold. An effect preview region 303 may be further set in the theme page 301. A representative preview image of the selected effect type may be displayed in the effect preview region 303 so that the user can determine whether the type needs to be changed and thus can be helped to rapidly select a satisfactory effect type.

At step 202, whether the target effect type is a text type is determined; and if the target effect type is the text type, step 203 is performed; if the target effect type is not the text type, step 204 is performed.

Exemplarily, compared with the effects of other types, a text type effect may express a variety of meanings for different copies. Therefore, regarding the text type effect, a plurality of choices may be provided or the text type effect may be defined by the user. When it is determined that the user has selected an effect type, whether the effect type is the text type may be determined first. For example, as exemplified above, whether the text firework type is selected may be determined first.

At step 203, an alternative copywriting corresponding to the target object is shown; a copywriting selection operation input by the first user for the alternative copywriting is received; and the first target effect of the target object is determined based on a target alternative copywriting indicated by the copywriting selection operation, and step 205 is performed.

Exemplarily, as shown in FIG. 3, if the user selects the text firework type, an alternative copywriting showing subpage 304 may pop up from the theme page 301. A plurality of alternative copies are shown in the subpage, such as Happy Spring Festival, 2022, Happy Tiger year, and happy life for your family as shown in FIG. 3. The user may select a certain alternative copywriting by tapping and the like, thereby determining the first target effect of the target object. For example, when the user selects Happy Spring Festival, the borders of the alternative copywriting are in bold and the first target effect of the target object is fireworks presenting the text “Happy Spring Festival”.

The above-mentioned heart-shaped firework type may be a composite effect type. When the first user selects the heart-shaped firework type, an invitation may be sent to the second user or the second user may be matched automatically. The left half and the right half of the heart-shaped fireworks are then displayed in the theme page for selection by the users. Assuming that the first user selects the left half and the second user selects the right half, for the first user side, the first target effect of the target object is the heart-shaped fireworks of the left half.

At step 204, the first target effect of the target object is determined based on the target effect type.

Exemplarily, for other firework types than the text firework type, to facilitate information interaction by the user based on the preset theme, after the target effect type is selected, an effect of the target effect type may be automatically determined as the first target effect of the target object. For example, one effect is set under each effect type, and after an effect type is selected, the set effect automatically becomes the target effect. For another example, a plurality of effects are set under each effect type, and after an effect type is selected, the target effect may be determined randomly.

At step 205, the first target effect is played in response to receiving a preset playing instruction for the target object and a preset playing control is displayed.

Exemplarily, as shown in FIG. 3, a preset control 305 may also be set in the theme page 301. After the user triggers the preset control 305 by tapping and the like, the user may enter an effect playing page 306 and play the dynamic fireworks of the text “Happy Spring Festival” in the effect playing page 306. The preset playing control, such as a tapping button 307 in the figure, is displayed in the effect playing page 306.

Exemplarily, if the first user selects the heart-shaped firework type, it is detected that both of the first user and the second user tap on the preset control 305 in 2 seconds after finishing selection, and the heart-shaped firework effect is determined based on the heart-shaped firework effect of the left half and the heart-shaped firework effect of the right half and is played. Moreover, the users together participate in information interaction based on the Spring Festival theme, and the interaction between the users is enhanced.

After receiving the preset playing instruction for the target object and before playing the first target effect, the method may further include determining a target playing background associated with the first user. For example, if the city where the first user is located is city A, an image containing an iconic building of the city A is obtained as a target playing background image. The target playing background image is displayed in the effect playing page 306 and a display attribute of the target playing background image is set to semitransparent to set off the playing of an effect.

When a target composite effect needs to be played, a target composite playing background associated with the first user and the second user may be determined and the target composite effect is played based on the composite playing background. An association manner may be association of a user attribute and a playing background. Exemplarily, a corresponding first target playing background is determined based on the user attribute of the first user and a corresponding second target playing background is determined based on the user attribute of the second user. An associated target composite playing background is determined based on the first target playing background and the second target playing background. For example, if the city where the first user is located is city A, an image containing an iconic building of the city A is obtained as a first target playing background image, and if the city where the second user is located is city B, an image containing an iconic building of the city B is obtained as a second target playing background image. A target composite playing background is generated based on the first target playing background image and the second target playing background image. The target composite playing background is displayed in the effect playing page 306 and the display attribute of the target playing background image is set to semitransparent to set off the playing of an effect.

At step 206, a current cumulative number of times of triggering the preset playing control is determined in response to a triggering operation for the preset playing control; a target preset atmospheric effect associated with the first target effect is determined based on the current cumulative number of times of triggering; and the target preset atmospheric effect is played in the process of playing the first target effect.

Exemplarily, after the user triggers the tapping button 307 by tapping and the like, the corresponding target preset atmospheric effect is played based on a current cumulative number of times of tapping. For example, after the user taps on the tapping button 307 once, one simulated firework effect is played as the background; and after the user taps on the tapping button 307 again, another simulated firework effect is played as the background.

Exemplarily, if the target composite effect is currently played, the numbers of times of triggering the preset playing control by the first user and the second user may be added together. For example, after the first user triggers the preset playing control once, one target preset atmospheric effect is played, and after the second user subsequently triggers the preset playing control once, the cumulative number of times of triggering is 2 and another target preset atmospheric effect will be played. The interaction between the users is enhanced.

At step 207, after the playing of the first target effect is finished, interaction task information associated with the preset theme is shown.

Exemplarily, after the playing of the first target effect is finished, the playing of the target preset atmospheric effect may be stopped. At this time, it may be considered that the user has successfully completed the interaction task of the preset theme and interaction task completion information may be fed back in the page. If the target composite effect is completely played, the first user and the second user may simultaneously obtain a corresponding feedback of interaction task completion.

According to the method for information interaction provided in the embodiment of the present disclosure, for the preset theme, a plurality of effect types are provided for selection by users, and personalized setting of a text type effect is supported. The target effect is played after the preset playing instruction for the selected target effect is received, and the preset playing control is displayed for the user to play an atmospheric effect. The interestingness is enhanced. The interaction task information of the preset theme is displayed after the effect is played completely. The interestingness of information interaction by the user based on the preset theme is improved and the information interaction forms are enriched.

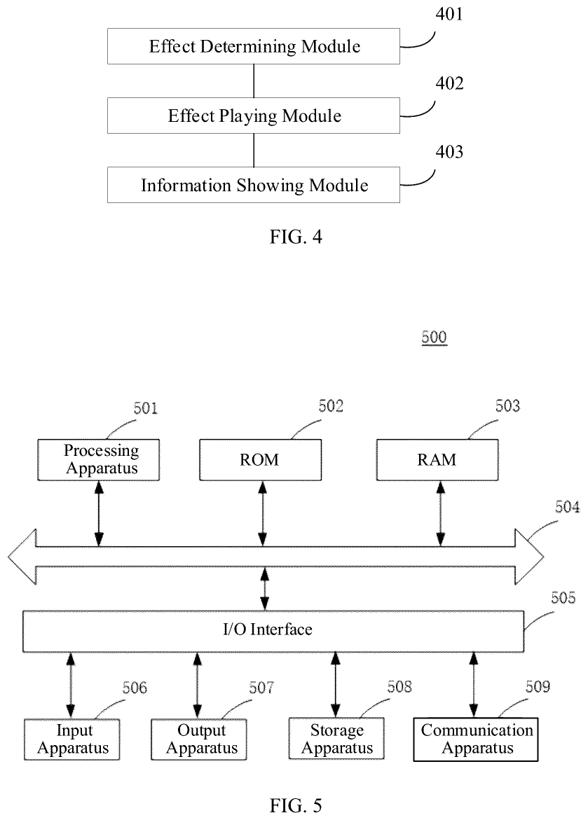

FIG. 4 is a structural block diagram of an apparatus for information interaction provided in an embodiment of the present disclosure. The apparatus may be implemented by software and/or hardware and may be generally integrated in an electronic device, and may carry out information interaction by performing the method for information interaction. As shown in FIG. 4, the apparatus includes:
an effect determining module 401 configured to determine a first target effect based on an effect selection operation input by a first user for a target object, where the target object is associated with a preset theme; an effect playing module 402 configured to play the first target effect in response to receiving a preset playing instruction for the target object; and an information showing module 403 configured to show interaction task information associated with the preset theme in response to determining that a preset condition is met.

According to the apparatus for information interaction provided in the embodiment of the present disclosure, the first target effect is determined based on the effect selection operation input by the first user for the target object, where the target object is associated with the preset theme. The first target effect is played in response to receiving the preset playing instruction for the target object. The interaction task information associated with the preset theme is shown in case of determining that the preset condition is met. By adopting the above technical solution, when performing information interaction based on the preset theme, the user may autonomously select the effect of the object associated with the preset theme and trigger showing the interaction task information associated with the preset theme by playing the effect. A novel theme-based information interaction manner is provided for the user; the interestingness of information interaction is improved; the information interaction forms are enriched; and the functions of an App are enriched.

In an embodiment, the effect determining module 401 includes:
a type determining unit configured to determine a target effect type based on an effect type selection operation input by the first user for the target object; and an effect determining unit configured to receive a setting operation input by the first user for the target effect type and determine the first target effect of the target object based on the setting operation.

In an embodiment, the target effect type includes a text type effect, and the effect determining unit is configured to:
show an alternative copywriting corresponding to the target object, receive a copywriting selection operation input by the first user for the alternative copywriting, and determine the first target effect of the target object based on a target alternative copywriting indicated by the copywriting selection operation; or receive a self-defined copywriting input by the first user and determine the first target effect of the target object based on the self-defined copywriting.

In an embodiment, the apparatus further includes:
a preset playing control display module configured to display a preset playing control after the playing the first target effect in response to receiving the preset playing instruction for the target object; and an atmospheric effect playing module configured to play a preset atmospheric effect associated with the first target effect in the process of playing the first target effect in response to a triggering operation for the preset playing control.

In an embodiment, the playing the preset atmospheric effect associated with the first target effect includes:
determining a current cumulative number of times of triggering the preset playing control, determining a target preset atmospheric effect associated with the first target effect based on the current cumulative number of times of triggering, and playing the target preset atmospheric effect.

In an embodiment, the apparatus further includes:
a user determining module configured to, after the determining the first target effect based on the effect selection operation input by the first user for the target object, determine a second user matching the first user and determine a second target effect selected by the second user; the effect playing module 402 is configured to:
detect that the first user and the second user trigger a playing operation on the target object in a same preset period of time, determine a target composite effect based on the first target effect and the second target effect, and play the target composite effect.

In an embodiment, the effect playing module 402 is configured to:
determine a target playing background associated with the first user and/or the first target effect in response to receiving the preset playing instruction for the target object, and play the first target effect based on the target playing background.

In an embodiment, the effect determining module 401 includes:
a candidate effect set determining unit configured to determine a candidate effect set corresponding to the target object based on progress information of the first user performing an interaction task associated with the preset theme; and a target effect determining unit configured to show the candidate effect set and determine the first target effect in accordance with the effect selection operation input by the first user based on the candidate effect set.

FIG. 5 is specifically referred below, and it shows the structure schematic diagram suitable for achieving the electronic device 500 in the embodiment of the present disclosure. The electronic device 500 in the embodiment of the present disclosure may include but not be limited to a mobile terminal such as a mobile phone, a notebook computer, a digital broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device 500 shown in FIG. 5 is only an example and should not impose any limitations on the functions and use scopes of the embodiments of the present disclosure.

As shown in FIG. 5, the electronic device 500 may include a processing apparatus (such as a central processing unit, and a graphics processor) 501, it may execute a plurality of appropriate actions and processes according to a program stored in a read-only memory (ROM) 502 or a program loaded from a storage apparatus 508 to a random access memory (RAM) 503. In RAM 503, a plurality of programs and data required for operations of the electronic device 500 are also stored. The processing apparatus 501, ROM 502, and RAM 503 are connected to each other by a bus 504. An input/output (I/O) interface 505 is also connected to the bus 504.

Typically, the following apparatuses may be connected to the I/O interface 505: an input apparatus 506 such as a touch screen, a touchpad, a keyboard, a mouse, a camera, a microphone, an accelerometer, and a gyroscope; an output apparatus 507 such as a liquid crystal display (LCD), a loudspeaker, and a vibrator; a storage apparatus 508 such as a magnetic tape, and a hard disk drive; and a communication apparatus 509. The communication apparatus 509 may allow the electronic device 500 to wireless-communicate or wire-communicate with other devices so as to exchange data. Although FIG. 5 shows the electronic device 500 with a plurality of apparatuses, it is not required to implement or possess all the apparatuses shown. Alternatively, it may implement or possess the more or less apparatuses.

According to the embodiment of the present disclosure, the process described above with reference to the flowchart may be achieved as a computer software program. For example, an embodiment of the present disclosure includes a computer program product, it includes a computer program carried on a non-transitory computer-readable medium, and the computer program includes program codes for executing the method shown in the flowchart. In such an embodiment, the computer program may be downloaded and installed from the network by the communication apparatus 509, or installed from the storage apparatus 508, or installed from ROM 502. When the computer program is executed by the processing apparatus 501, the above functions defined in the method in the embodiments of the present disclosure are executed.

The above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More examples of the computer-readable storage medium may include but not be limited to: an electric connector with one or more wires, a portable computer magnetic disk, a hard disk drive, a RAM, a ROM, an erasable programmable read-only memory (EPROM or flash memory), an optical fiber, a compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt a plurality of forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-mentioned computer-readable medium may be included in the electronic device described above, or may exist alone without being assembled into the electronic device.

The above-mentioned computer-readable medium carries one or more programs which, when executed by the electronic device, cause the electronic device to: determine a first target effect based on an effect selection operation input by a first user for a target object, where the target object is associated with a preset theme; play the first target effect in response to receiving a preset playing instruction for the target object; and show interaction task information associated with the preset theme in response to determining that a preset condition is met.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including local area network (LAN) or wide area network (WAN), or may be connected to an external computer (such as connected by using an internet service provider through the Internet).

The flowcharts and the block diagrams in the drawings show possibly achieved system architectures, functions, and operations of systems, methods, and computer program products according to a plurality of embodiments of the present disclosure. At this point, each box in the flowchart or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flowchart, as well as combinations of the boxes in the block diagram and/or the flowchart, may be achieved by using a dedicated hardware-based system that performs the specified function or operation, or may be achieved by using combinations of dedicated hardware and computer instructions.

The involved modules described in the embodiments of the present disclosure may be achieved by a mode of software, or may be achieved by a mode of hardware. The name of the module does not constitute a limitation for the module itself in a case. For example, the information showing module may also be described as “a module for showing interaction task information associated with the preset theme in response to determining that a preset condition is met”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard part (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

One or more embodiments of the present disclosure provide a method for information interaction, and the method includes:
determining a first target effect based on an effect selection operation input by a first user for a target object, where the target object is associated with a preset theme;
playing the first target effect in response to receiving a preset playing instruction for the target object; and
in response to determining that a preset condition is met, showing interaction task information associated with the preset theme.

According to one or more embodiments of the present disclosure, the determining a first target effect based on an effect selection operation input by a first user for a target object includes:
determining a target effect type based on an effect type selection operation input by the first user for the target object; and
receiving a setting operation input by the first user for the target effect type and determining the first target effect of the target object based on the setting operation.

According to one or more embodiments of the present disclosure, the target effect type includes a text type effect; and the receiving a setting operation input by the first user for the target effect type and determining the first target effect of the target object based on the setting operation includes:
showing an alternative copywriting corresponding to the target object, receiving a copywriting selection operation input by the first user for the alternative copywriting, and determining the first target effect of the target object based on a target alternative copywriting indicated by the copywriting selection operation; or
receiving a self-defined copywriting input by the first user and determining the first target effect of the target object based on the self-defined copywriting.

According to one or more embodiments of the present disclosure, after the playing the first target effect in response to receiving a preset playing instruction for the target object, the method further includes:
displaying a preset playing control; and
in response to a triggering operation for the preset playing control, playing a preset atmospheric effect associated with the first target effect in a process of playing the first target effect.

According to one or more embodiments of the present disclosure, the playing a preset atmospheric effect associated with the first target effect includes:
determining a current cumulative number of times of triggering the preset playing control, determining a target preset atmospheric effect associated with the first target effect based on the current cumulative number of times of triggering, and playing the target preset atmospheric effect.

According to one or more embodiments of the present disclosure, after the determining a first target effect based on an effect selection operation input by a first user for a target object, the method further includes:
determining a second user matching the first user and determining a second target effect selected by the second user;
where the playing the first target effect in response to receiving a preset playing instruction for the target object includes:
detecting that the first user and the second user trigger a playing operation on the target object in a same preset period of time, determining a target composite effect based on the first target effect and the second target effect, and playing the target composite effect.

According to one or more embodiments of the present disclosure, the playing the first target effect in response to receiving a preset playing instruction for the target object includes:
in response to receiving the preset playing instruction for the target object, determining a target playing background associated with at least one selected from the group consisting of the first user and the first target effect, and playing the first target effect based on the target playing background.

According to one or more embodiments of the present disclosure, the determining a first target effect based on an effect selection operation input by a first user for a target object includes:
determining a candidate effect set corresponding to the target object based on progress information of the first user performing an interaction task associated with the preset theme; and
showing the candidate effect set and determining the first target effect in accordance with the effect selection operation input by the first user based on the candidate effect set.

One or more embodiments of the present disclosure provide an apparatus for information interaction, and the apparatus includes:
an effect determining module configured to determine a first target effect based on an effect selection operation input by a first user for a target object, where the target object is associated with a preset theme;
an effect playing module configured to play the first target effect in response to receiving a preset playing instruction for the target object; and
an information showing module configured to show interaction task information associated with the preset theme in response to determining that a preset condition is met.

In addition, while the plurality of operations have been described in a particular order, it shall not be construed as requiring that such operations are performed in the stated specific order or sequence. Under certain circumstances, multitasking and parallel processing may be advantageous. Similarly, while the plurality of specific implementation details are included in the above discussions, these shall not be construed as limitations to the present disclosure. Some features described in the context of a separate embodiment may also be combined in a single embodiment. Rather, the plurality of features described in the context of a single embodiment may also be implemented separately or in any appropriate sub-combination in a plurality of embodiments.

1. A method for information interaction, comprising:
selecting a first target effect based on an effect selection operation input by a first user for a target object, wherein the target object is associated with a preset theme;
playing the first target effect in response to receiving a preset playing instruction for the target object; and
in response to meeting a preset condition, showing interaction task information associated with the preset theme.

2. The method according to claim 1, wherein the selecting a first target effect based on an effect selection operation input by a first user for a target object comprises:
selecting a target effect type based on an effect type selection operation input by the first user for the target object; and
receiving a setting operation input by the first user for the target effect type and selecting the first target effect of the target object based on the setting operation.

3. The method according to claim 2, wherein the target effect type comprises a text type effect; and the receiving a setting operation input by the first user for the target effect type and selecting the first target effect of the target object based on the setting operation comprises:
showing an alternative copywriting corresponding to the target object, receiving a copywriting selection operation input by the first user for the alternative copywriting, and selecting the first target effect of the target object based on a target alternative copywriting indicated by the copywriting selection operation; or
receiving a self-defined copywriting input by the first user and selecting the first target effect of the target object based on the self-defined copywriting.

4. The method according to claim 1, after the playing the first target effect in response to receiving a preset playing instruction for the target object, further comprising:
displaying a preset playing control; and
in response to a triggering operation for the preset playing control, playing a preset atmospheric effect associated with the first target effect in a process of playing the first target effect.

5. The method according to claim 4, wherein the playing a preset atmospheric effect associated with the first target effect comprises:
acquiring a current cumulative number of times of triggering the preset playing control, acquiring a target preset atmospheric effect associated with the first target effect based on the current cumulative number of times of triggering, and playing the target preset atmospheric effect.

6. The method according to claim 1, after the selecting a first target effect based on an effect selection operation input by a first user for a target object, further comprising:
acquiring a second target effect selected by a second user, wherein the second user is matched with the first user;
wherein the playing the first target effect in response to receiving a preset playing instruction for the target object comprises:
in response to detecting that the first user and the second user trigger a playing operation on the target object in a same preset period of time, acquiring a target composite effect based on the first target effect and the second target effect, and playing the target composite effect.

7. The method according to claim 1, wherein the playing the first target effect in response to receiving a preset playing instruction for the target object comprises:
in response to receiving the preset playing instruction for the target object, acquiring a target playing background associated with at least one selected from the group consisting of the first user and the first target effect, and playing the first target effect based on the target playing background.

8. The method according to claim 1, wherein the selecting a first target effect based on an effect selection operation input by a first user for a target object comprises:
acquiring a candidate effect set corresponding to the target object based on progress information of the first user performing an interaction task associated with the preset theme; and
showing the candidate effect set and selecting the first target effect in accordance with the effect selection operation input by the first user based on the candidate effect set.

9. (canceled)

10. An electronic device, comprising a memory, a processor, and a computer program stored on the memory and runnable on the processor, wherein the processor, upon executing the computer program, implements a method for information interaction, and the method comprises:
selecting a first target effect based on an effect selection operation input by a first user for a target object, wherein the target object is associated with a preset theme;
playing the first target effect in response to receiving a preset playing instruction for the target object; and
in response to meeting a preset condition, showing interaction task information associated with the preset theme.

11. A non-transitory computer-readable storage medium, storing computer programs, wherein the computer programs, upon being executed by a processor, implement a method for information interaction, and the method comprises:
selecting a first target effect based on an effect selection operation input by a first user for a target object, wherein the target object is associated with a preset theme;
playing the first target effect in response to receiving a preset playing instruction for the target object; and
in response to meeting a preset condition, showing interaction task information associated with the preset theme.

12. (canceled)

13. The electronic device according to claim 10, wherein the selecting a first target effect based on an effect selection operation input by a first user for a target object comprises:
selecting a target effect type based on an effect type selection operation input by the first user for the target object; and
receiving a setting operation input by the first user for the target effect type and selecting the first target effect of the target object based on the setting operation.

14. The electronic device according to claim 13, wherein the target effect type comprises a text type effect; and the receiving a setting operation input by the first user for the target effect type and selecting the first target effect of the target object based on the setting operation comprises:
showing an alternative copywriting corresponding to the target object, receiving a copywriting selection operation input by the first user for the alternative copywriting, and selecting the first target effect of the target object based on a target alternative copywriting indicated by the copywriting selection operation; or
receiving a self-defined copywriting input by the first user and selecting the first target effect of the target object based on the self-defined copywriting.

15. The electronic device according to claim 10, after the playing the first target effect in response to receiving a preset playing instruction for the target object, further comprising:
displaying a preset playing control; and
in response to a triggering operation for the preset playing control, playing a preset atmospheric effect associated with the first target effect in a process of playing the first target effect.

16. The electronic device according to claim 15, wherein the playing a preset atmospheric effect associated with the first target effect comprises:
acquiring a current cumulative number of times of triggering the preset playing control, acquiring a target preset atmospheric effect associated with the first target effect based on the current cumulative number of times of triggering, and playing the target preset atmospheric effect.

17. The electronic device according to claim 10, after the selecting a first target effect based on an effect selection operation input by a first user for a target object, further comprising:
acquiring a second target effect selected by a second user, wherein the second user is matched with the first user;
wherein the playing the first target effect in response to receiving a preset playing instruction for the target object comprises:
in response to detecting that the first user and the second user trigger a playing operation on the target object in a same preset period of time, acquiring a target composite effect based on the first target effect and the second target effect, and playing the target composite effect.

18. The electronic device according to claim 10, wherein the playing the first target effect in response to receiving a preset playing instruction for the target object comprises:
in response to receiving the preset playing instruction for the target object, acquiring a target playing background associated with at least one selected from the group consisting of the first user and the first target effect, and playing the first target effect based on the target playing background.

19. The electronic device according to claim 10, wherein the selecting a first target effect based on an effect selection operation input by a first user for a target object comprises:
acquiring a candidate effect set corresponding to the target object based on progress information of the first user performing an interaction task associated with the preset theme; and
showing the candidate effect set and selecting the first target effect in accordance with the effect selection operation input by the first user based on the candidate effect set.
